(19) United States
(12) Patent Application Publication
(10) Pub. No.: US 2019/0194781 A1
(43) Pub. Date: Jun. 27, 2019

(54) ALUMINUM ALLOY POWDER FOR ADDITIVE MANUFACTURING, AND METHOD FOR MANUFACTURING A PIECE BY MANUFACTURING FROM THIS POWDER

(71) Applicant: THALES, Courbevoie (FR)

(72) Inventors: Pierre ELOI, Valence (FR); Claude SARNO, Valence (FR)

(21) Appl. No.: 16/227,210

(22) Filed: Dec. 20, 2018

(30) Foreign Application Priority Data
Dec. 26, 2017 (FR) 17 01369

(51) Int. Cl. C22C 21/08; B33Y 10/00; B33Y 70/00; C22C 1/04; B22F 9/08; B22F 1/00; B22F 3/105; B23K 26/354; B23K 26/34

(52) U.S. Cl. CPC C22C 21/08; B33Y 10/00; B33Y 70/00; C22C 1/0416; B33Y 80/00; B22F 1/0007; B22F 3/1055; B23K 26/354; B23K 26/34; B22F 9/082

(57) ABSTRACT

An aluminum alloy powder for additive manufacturing, and method for manufacturing a piece by manufacturing from this powder are disclosed. In one aspect, the alloy powder is composition by weight: Al_{comp}SiₐMg_{b}Zr_{c}R_{d} wherein R represents one or more elements selected from the group consisting of Mn, Cr, Cu, Zn and Ti, and wherein, in percent by weight: a is between 0.2% and 1%, b is between 0.3% and 1.7%, c is between 0.4% and 5%, and d is between 0% and 1%, wherein the balance consists of aluminum and unavoidable impurities.

### CROSS-REFERENCE TO RELATED APPLICATIONS

This patent application claims the benefit under 35 U.S.C. § 119 of French Application No. FR 17 01369 filed on Dec. 26, 2017, which is hereby incorporated by reference in its entirety.

### BACKGROUND

### Technological Field

The described technology relates to an aluminum alloy powder for the manufacture of parts by an additive manufacturing method and to a method of manufacturing such a powder. The described technology also relates to a method of manufacturing a part by additive manufacturing from this powder, and an aluminum alloy part produced by this method.

### Description of the Related Technology

Additive manufacturing is a method that involves layer-by-layer construction or addition manufacturing, as opposed to material removal in conventional machining. Additive manufacturing methods include, but are not limited to, selective laser melting (SLM), selective laser sintering (SLS), and direct metal deposition (DMD).

### SUMMARY OF CERTAIN INVENTIVE ASPECTS

The described technology applies, in particular, to the manufacture of parts in the aeronautical field, but may also be applied in the automotive field, or any other field.

For such applications, it is known to use titanium alloys as they offer good mechanical properties, especially in terms of hardness, ductility and fatigue resistance.

Due to the complexity of the shapes of the parts to be produced, it has been proposed to produce the parts by additive manufacturing techniques. Indeed these techniques offer the possibility of making parts of complex shapes that would be difficult to achieve, or would not be achievable at all, by using conventional methods such as casting, forging or machining.

Such a method comprises, for example, in the case of melting or selective laser sintering, a step during which a first layer of powder of the alloy is deposited on a manufacturing support, followed by a step of heating a predefined area of the powder layer with a heating means (for example a laser or an electron beam). These steps are repeated iteratively for each additional layer, until the final part is obtained layer by layer.

Requirements in terms of weight have also led to the use of aluminum alloy, for example Al-8009 alloy, or alloys of the Al-6000 series (Al—Mg—Si), for example Al-6061.

In particular, alloys of the Al-6000 series are used for parts for which high thermal conductivity is sought, for example greater than 130 W/m° C., in combination with good mechanical properties, for example a tensile modulus of elasticity over 60 GPa, as well as good anodizing and welding properties and good corrosion resistance.

Such alloys typically comprise, in percentage by weight, up to 2%, generally up to 1% of silicon, up to 1.5% of magnesium, and, optionally, one or more additional elements selected from Mn, Cr, Cu, Zn and Ti, the rest being aluminum and unavoidable impurities. These impurities comprise, for example, iron, the content of which must nevertheless remain less than 1%.

For the above reasons, it is desirable to produce parts from the powders of these alloys by additive manufacturing techniques.

For example, document EP 2 796 229 discloses a method for manufacturing an aluminum alloy by additive manufacturing from a powder of the alloy Al-8009, according to which different parts of this alloy powder are successively subjected to a laser beam and then cooled to form a part, layer by layer.

However, the manufacture of an Al-6000 series alloy part by an additive manufacturing method is problematic. Indeed, a part made from such an alloy through additive manufacturing presents strong residual stresses inducing deformation phenomena or even cracks along the grain boundaries in the part and at the interface between the part and the manufacturing support.

Such cracks may lead to premature breakage of the part and create porosities within the part that are incompatible with certain uses.

To solve the problems of cracking in an aluminum alloy, it is known to add silicon in a content greater than 2%, or iron. These elements make it possible to reduce the grain size and to provide a structural hardening to the material by the formation of MgₓSiₓ or Fe₃Al precipitates.

However, the supplementary addition of Si and/or Fe is not possible in an alloy of the Al-6000 series, insofar as the addition of these elements does not allow the desired physical, mechanical and chemical properties to be obtained. In particular, the addition of Si at a content greater than 2% and/or Fe, would lead to a decrease in thermal conductivity, the mechanical properties of the alloy, the anodizing ability, and the resistance to corrosion.

To solve the problem of cracking, it has been proposed to subject the parts resulting from additive manufacturing to hot isostatic pressing (HIP) post-treatment.

However, this solution is not satisfactory. In particular, such treatment results in non-acceptable dimensional variations of the parts, and significantly increases the cost of manufacturing the parts.

One object of the described technology is, therefore, to provide an aluminum alloy powder and a method of manufacturing this powder that allows the manufacture, by an additive manufacturing method, of a part that is free of cracking, while retaining good properties, in particular the properties offered by the alloys of the Al-6000 series, especially high thermal conductivity.

For this purpose, one inventive aspect relates to an alloy powder of composition by weight: Al_{comp}SiₐMg_{b}Zr_{c}R_{d}, wherein R represents one or more elements selected from the group consisting of Mn, Cr, Cu, Zn and Ti, and wherein, as a percentage by weight: a is between 0.2% and 1%, b is between 0.3% and 1.7%, c is between 0.4% and 5%, and d is between 0% and 1%, while the balance consists of aluminum and unavoidable impurities.

Preferably, the zirconium content, in weight percent, in the alloy powder is greater than 1%.

In this context, it has been found that the risk of cracking results, in particular, from the grain size of the alloys of the Al-6000 series, which may reach several hundred microns on average. This large grain size increases the residual intergranular stresses, which promotes the appearance of cracks in the part.

The inventors have furthermore discovered that the addition of zirconium in the alloy powder makes it possible not only to reduce the grain size of the part produced by additive manufacturing from such a powder, but also makes it possible to retain the same mechanical, physical and chemical properties.

The reduction of the grain size makes it possible to reduce residual intergranular stresses, and thus to reduce the risk of cracks appearing in the part.

The powder according to the described technology is in particular intended to be used for manufacturing an aluminum alloy part using the selective melting additive manufacturing technique, in particular using a laser beam (“selective laser melting”). The powder in particular has a grain size adapted for use of the selective laser melting additive manufacturing technique, in particular using a laser beam, reducing the risk of cracks appearing in the part during solidification. Furthermore, the powder is in particular compatible with the cooling speeds associated with selective melting, in particular using a laser beam.

According to another aspect, the particle size is less than 150 μm, in particular comprised between 1 μm and 100 μm.

The described technology also relates to a method for manufacturing an alloy powder according to the described technology, wherein the method is characterized in that it comprises the following steps:

providing one or more precursor materials comprising aluminum, silicon, magnesium and, optionally, one or more elements selected from the group consisting of Mn, Cr, Cu, Zn and Ti,

providing at least one addition material comprising zirconium,

combining the precursor materials and the addition material to form the alloy powder.

According to other aspects, the manufacturing method comprises one or more of the following features:

the precursor materials are provided in the form of at least one alloy precursor powder, wherein the addition material is supplied in the form of a powder comprising zirconium, and the step of combining the precursor alloy materials and the addition material comprises a mechanical mixture of the alloy precursor powder and the powder comprising zirconium, so as to obtain an alloy powder with a particle size of between 1 μm and 150 μm,

the precursor materials and the addition material are supplied in the form of solids, while the step of combining the precursor materials and the addition material involves grinding of the solids,

the step of combining the precursor materials and the addition material comprises a step of melting a mixture of the precursor materials and the addition material, and a step of atomization under neutral gas of the melted mixture so as to obtain powder particles with a particle size of less than 150 μm,

the alloy precursor powder is a powder of the alloy Al-6061.

The described technology also relates to a method for manufacturing an aluminum alloy by additive manufacturing by melting or sintering powder particles using a high energy density beam, in particular a high energy density laser beam.

In other aspects, the manufacturing method comprises one or more of the following features:

the method comprises the implementation of at least one additive manufacturing technique chosen from the direct metal deposition technique, the selective laser melting technique, the selective laser sintering technique and the Electron Beam Melting (EBM) technique,

the method comprises providing the alloy powder and the implementation of the succession of steps (b) to (d) as follows:

(b) heating a portion of the alloy powder by means of the high energy density beam,

(c) removing the high energy density beam from the alloy powder portion,

(d) cooling the alloy powder portion at a cooling rate greater than or equal to 10³° C./sec.

the method further comprises, before step (b), a step (a) of depositing a layer of the alloy powder on a support, wherein step (b) of heating the portion of the alloy powder is implemented by directing the high energy density beam onto a region of the deposited alloy powder layer forming the alloy powder portion,

the cooling of the portion of the alloy powder occurs as a result of the step (c) of removing the laser beam,

steps (b) to (d) are carried out in a heated closed enclosure, or in a closed enclosure under a protective atmosphere of an inert gas, in particular argon, wherein the weight percentage of oxygen in the atmosphere is less than 5000 ppm,

the step of providing the alloy powder comprises implementing the alloy powder manufacturing method as described above.

The described technology also relates to an aluminum alloy part obtained by a manufacturing method as disclosed above, wherein the alloy has the following weight composition: Al_{comp}SiₐMg_{b}Zr_{c}R_{d}, wherein R represents one or more elements selected from the group consisting of Mn, Cr, Cu, Zn and Ti, and, wherein, in weight percentage: a is between 0.2% and 1%, b is between 0.3% and 1.7%, c is between 0.4% and 5%, and d is between 0% and 1% by weight percentage, wherein the balance consists of aluminum and unavoidable impurities.

Preferably, the alloy comprises a zirconium content, in weight percentage, greater than 1%.

In another aspect, the part has an equiaxial grain structure, and the grains have an average size of less than 50 μm.

### BRIEF DESCRIPTION OF THE DRAWINGS

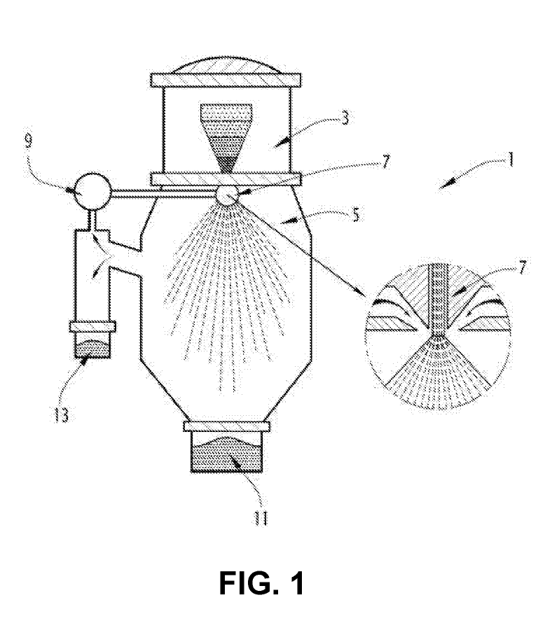

The described technology will be further understood through reference to embodiments of the described technology as described below with reference to the FIG. 1, which schematically illustrates an atomization device for the implementation of the method for manufacturing the alloy powder according to one embodiment.

### DETAILED DESCRIPTION OF CERTAIN INVENTIVE EMBODIMENTS

The aluminum alloy powder according to the described technology has the following composition by weight:

Al_{comp}SiₐMg_{b}Zr_{c}R_{d}

wherein R is at least one element selected from the group consisting of Mn, Cr, Cu, Zn and Ti, and wherein

a is between 0.2% and 1%, in percentage by weight,

b is between 0.3% and 1.7%, in percentage by weight,

c is between 0.4% and 5%, in percentage by weight, and

d is between 0% and 1%, in percentage by weight,

wherein the complement (comp) consists of aluminum and unavoidable impurities.

The addition of silicon makes it possible to reduce the melting temperature of the alloy and to improve the fluidity thereof. In addition, the combined addition of magnesium and silicon allows the formation of MgₓSi components involved in the structural hardening of the material.

For this purpose, the silicon content must be greater than 0.2% and the magnesium content must be greater than 0.3%.

However, beyond 1% of silicon, the thermal conductivity of the alloy is degraded. Also, the Si content must be less than 1%, and preferably less than 0.8% by weight.

The weight content of Mg is limited to 1.7%, for example less than or equal to 1.5%, especially less than or equal to 1.2%, in order to promote the presence of hardening precipitates.

The weight content of Mg is, for example, between 0.8% and 1.2%.

Optionally, the composition of the alloy powder comprises one or more elements selected from the group consisting of Mn, Cr, Cu, Zn and Ti, while the total content of these elements is less than 1%.

In particular, manganese and chromium may be added in order to neutralize the harmful effect of iron as an impurity on the resistance to corrosion, in particular on the resistance to pitting corrosion.

Copper and zinc, when present, improve the mechanical properties of the alloy formed from the powder.

The composition of the alloy powder according to the described technology further comprises from 0.3% to 5% by weight of zirconium.

The inventors have, indeed, found that the addition of zirconium in the composition of the powder has the effect of reducing the grain size in the part formed by additive manufacturing, thus reducing cracking during solidification.

In particular, the inventors have discovered that zirconium acts as nuclides due to its structural similarity with the face-centered cubic (CFC) aluminum matrix and due to the similarity of its lattice parameter with that of the CFC matrix. The addition of zirconium thus makes it possible to increase the number of grains of the aluminum matrix and thus to reduce their size significantly.

The addition of zirconium also makes it possible to increase the isotropy of the alloy, since the orientation of the grains is no longer textured along the {001} plane in the cooling direction, as well as the formation of Al—Zr particles, which serve as hardening precipitates.

This strong isotropy and the presence of Al—Zr particles increase the mechanical characteristics of the alloy, especially its mechanical strength and ductility.

A weight content of at least 0.4% of TiB₂ is necessary to obtain this effect. Above 5%, the alloy is potentially non-atomizable due to the low solubility of TiB₂ in aluminum at the usual atomization temperatures.

According to one embodiment, the Zr mass content is greater than 0.5%, or even greater than 1%.

The complement of the composition of the powder consists of aluminum and unavoidable impurities.

The impurities comprise, for example, up to 1% by weight of iron, preferably at most 0.70%.

The alloy powder according to the described technology corresponds, for example, to an alloy powder of the Al-6000 family, for example the alloy Al-6061, to which zirconium has been added in a weight proportion making it possible to obtain the aforementioned alloy powder composition.

According to a preferred embodiment, the alloy powder has the following composition by weight:

Al_{comp}SiₐMg_{b}Zr_{c}Cu_{d1}Cr_{d2}Mn_{d3}Zn_{d4}

wherein, in percent by weight:

a is between 0.4% and 0.8%,

b is between 0.8% and 1.2%,

c is between 0.4% and 5%,

d1 is between 0.15% and 0.40%,

d2 is between 0.04% and 0.35%,

d3 is less than or equal to 0.15%, and

d4 is less than or equal to 0.15%,

and wherein d1+d2+d3+d4<1%,

wherein the balance consists of aluminum and unavoidable impurities, including for example up to 0.70% of iron.

Preferably, the alloy powder has a particle size less than 150 μm, for example less than 100 μm, and generally greater than one μm.

The aluminum alloy powder according to the described technology is, for example, manufactured from one or more precursor materials comprising aluminum, magnesium, silicon, and, optionally, at least one element selected from the group consisting of Mn, Cr, Cu, Zn and Ti, and an addition material comprising zirconium.

The method for preparing the alloy powder thus comprises:

a step of supplying the precursor material(s),

a step of supplying the addition material, and

a step of combining the precursor material(s) with the addition material to form the alloy powder.

The contents of the various elements of the precursor materials and of the addition material are chosen as a function of the final composition of the desired alloy powder, taking into account, of course, the dilution effect resulting from the mixing of the materials.

The precursor material(s) are, for example, provided in the form of one or more powder(s), hereinafter referred to as the alloy precursor powder(s).

The addition material is for example provided in the form of a powder comprising zirconium, hereinafter referred to as zirconium powder.

Alternatively, the precursor materials and the addition material may be provided in the form of solids which are then ground into the form of powders.

The method for preparing the alloy powder thus comprises:

a step of supplying the alloy precursor powder(s) comprising aluminum, magnesium, silicon, and, optionally at least one element selected from the group consisting of Mn, Cr, Cu, Zn and TI,

a step of supplying the zirconium powder, and

a step of combining the precursor alloy powder(s) with the zirconium powder to form the alloy powder.

The contents of the various elements of the precursor powder are chosen as a function of the final composition of the desired alloy powder.

The precursor powder has, for example, the following composition by weight:

Al_{comp}Siₐ.Mg_{b}.R_{d}.

wherein R is at least one element selected from the group consisting of Mn, Cr, Cu, Zn and Ti,

and wherein, in percent by weight:

a′ is between 0.2% and 1.1%,

b′ is between 0.3% and 1.8%, and

d′ is between 0% and 1%,

the balance consisting of aluminum and unavoidable impurities.

The precursor powder is generally an alloy powder of the Al-6000 series, for example a powder of the alloy Al-6061 of the following composition by weight:

Al_{comp}SiₐMg_{b}Cu_{d1}Cr_{d2}Mn_{d3}Zn_{d4}

wherein, in percent by weight:

a is between 0.4% and 0.8%,

b is between 0.8% and 1.2%,

d1 is between 0.15% and 0.40%,

d2 is between 0.04% and 0.35%,

d3 is less than or equal to 0.15%, and

d4 is less than or equal to 0.15%,

and wherein d1+d2+d3+d4 is less than or equal to 1%,

the balance consisting of aluminum and unavoidable impurities, including for example up to 0.70% of iron.

The zirconium powder for example consists of zirconium.

Alternatively, the zirconium powder consists of a mixture of aluminum and zirconium.

According to a first embodiment, the alloy precursor powder(s) and the zirconium powder are combined by mechanical mixing, in order to obtain a homogeneous alloy powder of particle size of between 1 μm and 100 μm. The mechanical mixture is, for example, made by grinding and blending.

According to a second embodiment, the precursor and addition materials are combined in a crucible and then atomized under a neutral gas.

In this embodiment, the precursor and addition materials are for example provided in the form of powder or pre-alloyed bars.

In this embodiment, the step of combining the precursor and addition materials comprises, for example

melting the mixture of precursor materials and of the addition material until a bath which is homogeneous in terms of chemical composition is achieved,

atomization under neutral gas of the molten mixture to form powder particles having a particle size of less than 150 During this atomization, the molten mixture is pulverized into fine droplets by a jet of gas under high pressure. The droplets then solidify as powder particles.

The jet of gas is for example a jet of neutral gas, for example nitrogen, helium, argon, or a mixture of these gases.

By way of example, FIG. 1 illustrates a gas atomization device 1.

This device comprises a melting chamber or autoclave 3, into which are introduced the alloying elements which are melted therein to produce a molten mixture, under a blanket of air or inert gas, or under vacuum.

The atomization device further comprises an atomization chamber 5, an atomization nozzle 7 and a gaseous source 9.

The atomization nozzle 7 is configured to spray the molten mixture from the melting chamber 3 in the form of fine droplets into the atomization chamber 5 by means of a jet of high-pressure gas supplied by the gaseous source 9.

The atomization chamber 5 comprises, in its lower part, a collection chamber 11 in which the particles of powder resulting from the solidification of these droplets are collected.

The gaseous source 9 is provided with a pump capable of collecting the gas injected into the chamber for reinjecting it via the atomization nozzle 7.

The atomization chamber 5 further comprises an ancillary collection chamber 13 for collecting the powder particles entrained by the pump during collection of the gas.

The alloy powder according to the described technology is used for the manufacture of parts by additive manufacturing, by melting or sintering particles of the alloy powder by means of a high energy beam.

The high energy beam is, for example, a high energy density laser beam, for example developing a specific power of the order of 10⁵ W/cm².

The additive manufacturing method involves, for example, a melting or selective sintering technique using a laser on a powder bed, or a laser projection technique.

The implementation of the manufacturing method according to these techniques comprises in all cases a step of supplying the alloy powder, and the implementation of the following steps (b) to (d):

(b) heating a portion of the powder at a temperature which may be higher or lower than the melting temperature of the alloy powder by means of the high energy density beam,

(c) removing the high energy density beam from the alloy powder portion,

(d) cooling the alloy powder portion at a cooling rate greater than or equal to 10⁴° C./sec.

The cooling, during step (d), of the region of the alloy powder occurs, for example, as a consequence of the removal during step (c) of the high energy density beam.

In step (d), the portion of heated powder solidifies to form a layer of the part.

In addition, the structure of the alloy formed after cooling is a non-textured equiaxial grain structure, consisting of fine grains of micron or even submicron size, in particular of average size less than 50 μm, or even less than one μm.

Steps (b) to (d) may be implemented again iteratively, to form successive or adjacent layers of the part.

Selective Laser Melting (SLM) is an additive manufacturing technique that enables the production of parts from an alloy powder by selectively, i.e. locally, melting a region of a layer of alloy powder deposited on a support.

The selective laser sintering (SLS) technique essentially differs from the selective laser melting technique in that the region of the alloy powder layer is not brought to a temperature greater than the melting temperature, but is sintered.

The implementation of the manufacturing method by sintering or selective laser melting further comprises, before step (b) or before each step (b), a step (a) of depositing a layer of the alloy powder on a support.

The support is, for example, a manufacturing platform, or a layer of the part, of previously deposited or projected powder.

During step (a), the layer of alloy powder is thus, for example, deposited on the manufacturing platform, or on a layer of the part previously manufactured by the implementation of steps (a) to (d).

In step (b), the laser beam is directed at a region of the deposited powder layer. The powder portion mentioned with reference to steps (b) and (d) then corresponds to the region of the powder layer on which the laser beam is directed.

In the selective laser melting technique, during step (b), the region of the alloy powder layer is raised to a temperature above the melting temperature of this alloy powder in order to form a molten region.

In the selective laser sintering technique, in step (b), the region of the alloy powder layer is not brought to a temperature above the melting temperature, but is sintered.

The shape of the region on which the laser beam is directed, which is not necessarily convex, corresponds to a layer of the manufactured part.

Only this region is selectively heated by the laser beam. The layer of powder deposited during step (a) thus comprises a melted or sintered region, and one or more unmelted and unsintered powder regions.

In step (d), the melted or sintered region solidifies to form a layer of the part.

Steps (a) to (d) may again be implemented iteratively to form successive or adjacent layers of the part.

For example, during each step (a), each new layer of powder may be deposited on the layer of powder deposited during the previous iteration, or at a distance from this previous layer.

The excess of powder, corresponding to the unmelted portions of the powder layer, may then be recovered, either at the end of the manufacturing method, or at the end of each succession of steps (a) to (d), or at the end of some of the successions of steps (a) to (d).

The Direct Metal Deposition (DMD) technique, consists in emitting a high energy density laser beam on a substrate while projecting powder by means of a projection nozzle that is coaxial to the laser beam. The powder is heated by the laser beam during its transport to the substrate and is deposited in the form of molten powder on this substrate. The geometry of the part is obtained by displacing, on the one hand, the substrate in a plane, and, on the other hand, the laser beam orthogonally to this plane. The part is then fabricated layer by layer from the design data of this part.

Thus, during step (b), the portion of alloy powder is both heated and projected on the support.

The manufacturing method according to the described technology is preferably implemented in a closed chamber, i.e. isolated from the external environment.

In particular, the manufacturing method is preferably carried out in a closed enclosure under a protective atmosphere of an inert gas, wherein the weight percentage of oxygen in the atmosphere is less than 5000 ppm. This protective atmosphere makes it possible to prevent the contamination of the part, in particular by oxygen which can lead to oxidation, during manufacture.

The inert gas is, for example, argon, nitrogen, helium or other neutral gas, or a mixture of these gases.

The enclosure and/or the manufacturing support may be heated in order to limit residual stresses in the part and deformations of the part during cooling.

The part produced by such a manufacturing method has a composition corresponding to that of the alloy powder used.

In addition, the structure of the alloy of the part is a non-textured equiaxial grain structure, consisting of fine grains of micron or submicron size.

As a result, the residual stresses in the part are greatly diminished, compared to a part that would be made of a similar alloy but devoid of Zr. The part is thus free of cracks, and therefore has a greatly reduced risk of premature rupture.

In addition, the structure of the part comprises Al—Zr particles acting as hardening precipitates.

The part thus obtained typically has a thermal conductivity greater than 130 W/m° C.

The alloy powder according to the described technology thus makes it possible to manufacture, by an additive manufacturing method, a part that is free of cracking, while retaining good properties, in particular the properties offered by the alloys of the Al-6000 series, especially a high thermal conductivity.

While there have been shown and described and pointed out the fundamental novel features of the invention as applied to certain inventive embodiments, it will be understood that the foregoing is considered as illustrative only of the principles of the invention and not intended to be exhaustive or to limit the invention to the precise forms disclosed. Modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplate. All such modifications and variations are within the scope of the invention as determined by the appended claims when interpreted in accordance with the breadth to which they are entitled.

What is claimed is:

1. An alloy powder having the following composition:
Al_{comp}SiₐMg_{b}Zr_{c}R_{d}
wherein R represents one or more elements selected from the group consisting of Mn, Cr, Cu, Zn and Ti,
wherein, in percent by weight:
a is between 0.2% and 1%,
b is between 0.3% and 1.7%,
c is between 0.4% and 5%,
and d is between 0% and 1%,
wherein the balance consists of aluminum and impurities, and
wherein the zirconium content, in weight percent, is greater than 1%.

2. The alloy powder according to claim 1, wherein the particle size is less than 150 μm.

3. The alloy powder according to claim 1, wherein the particle size is between 1 μm and 100 μm.

4. A method of manufacturing an alloy powder according to claim 1, wherein the method comprises:
providing one or more precursor materials comprising aluminum, silicon, and magnesium,
providing at least one addition material comprising zirconium, and
combining the precursor materials and the addition material to form the alloy powder.

5. The method of claim 4, wherein the precursor materials further comprise one or more elements selected from the group consisting of Mn, Cr, Cu, Zn and Ti.

6. The method of manufacturing according to claim 4, wherein the precursor materials are provided in the form of at least one alloy precursor powder, the addition material is supplied in the form of a powder comprising zirconium, and the combining the precursor alloy materials and the addition material comprises a mechanical mixture of the alloy precursor powder and the powder comprising zirconium, so as to obtain an alloy powder having a particle having a size between 1 μm and 150 μm.

7. The method of manufacturing according to claim 5, wherein the precursor materials and the addition material are provided in the form of solids, while the combining the precursor materials and the addition material comprises grinding the solids.

8. The method of manufacturing according to claim 4, wherein the combining the precursor materials and the addition material comprises melting a mixture of the precursor materials and the addition material, and neutral gas atomization of the molten mixture so as to obtain powder particles with a particle size of less than 150 μm.

9. The method of manufacturing according to claim 5, wherein the alloy precursor powder is a powder of the alloy Al-6061.

10. A method for manufacturing an aluminum alloy part by additive manufacturing comprising melting or sintering powder particles by means of a high energy density beam, wherein the powder is the alloy powder according to claim 1.

11. The method according to claim 9, wherein the high energy density beam comprising a high energy density laser beam.

12. The method of manufacturing according to claim 9, further comprising implementation, on the powder, of at least one additive manufacturing technique selected from a direct metal deposition technique, a selective laser melting technique, a selective laser sintering technique and an Electron Beam Melting (EBM) technique.

13. The method of manufacturing according to claim 9, comprising providing the alloy powder according to claim 1, and the implementation of the succession of steps (b) to (d) as follows:
(b) heating, by means of the high energy density beam, a portion of the alloy powder,
(c) removing the high energy density beam from the alloy powder portion, and
(d) cooling the alloy powder portion at a cooling rate greater than or equal to 10³° C./sec.

14. The method of manufacturing according to claim 12, further comprising, before step (b), a step (a) of depositing a layer of the alloy powder on a support, wherein the step (b) of heating the portion of the alloy powder comprises directing the high energy density beam onto a region of the deposited alloy powder layer forming the portion of alloy powder.

15. The method of manufacturing according to claim 12, wherein the cooling of the portion of the alloy powder occurs as a result of the step (c) of removal of the laser beam.

16. The method of manufacturing according to claim 12, wherein the steps (b) to (d) are implemented in a heated closed chamber or in a closed chamber under a protective atmosphere of an inert gas and wherein the mass percentage of oxygen in said atmosphere is less than 5000 ppm.

17. The method according to claim 15, wherein the inert gas comprises argon.

18. The method of manufacturing according to claim 12, wherein the providing the alloy powder comprises:
providing one or more precursor materials comprising aluminum, silicon, and magnesium,
providing at least one addition material comprising zirconium, and
combining the precursor materials and the addition material to form the alloy powder.

19. An aluminum alloy part obtained by a manufacturing method according to claim 9, wherein the alloy has the following composition:
Al_{comp}SiₐMg_{b}Zr_{c}R_{d}
wherein R represents one or more elements selected from the group consisting of Mn, Cr, Cu, Zn and Ti,
wherein, in percent by weight:
a is between 0.2% and 1%,
b is between 0.3% and 1.7%,
c is between 0.4% and 5%,
and d is between 0% and 1%,
wherein the balance consists of aluminum and impurities, and
wherein the alloy comprises a zirconium content, in weight percentage, greater than 1%.

20. The aluminum alloy part according to claim 18, having an equiaxial grain structure, wherein the grains have an average size less than 50 μm.
